(19) United States
(12) Patent Application Publication
(10) Pub. No.: US 2018/0219836 A1
(43) Pub. Date: Aug. 2, 2018

(54) Distributed Data System

(71) Applicants: Ryan Peterson, Discovery Bay, CA (US); Julia Clavien, San Francisco, CA (US); Daniel Gilligan, Erskineville (AU)

(72) Inventors: Ryan Peterson, Discovery Bay, CA (US); Julia Clavien, San Francisco, CA (US); Daniel Gilligan, Erskineville (AU)

(21) Appl. No.: 15/419,834

(22) Filed: Jan. 30, 2017

(51) Int. Cl. H04L 29/06; H04L 12/66; H04L 29/08; G06F 17/30

(52) U.S. Cl. CPC H04L 63/04; H04L 12/66; G06F 17/3033; H04L 63/20; G06F 17/30867; H04L 67/1097

(57) ABSTRACT

A distributed data system has a network, a first organization connected to the network having a first database having personal identifiable information, the personal identifiable information divisible into a plurality of components, and having a first token associated with the personal identifiable information, and a first personal information gateways in communication with the first database and the network, wherein the personal information gateway is configured to divide the personal identifiable information into a plurality of data shreds, each data shred corresponding to a component, as well as a plurality of matching nodes connected to the network, wherein the nodes are configured to match data, wherein each data shred is configured to be transmitted to a matching node receiving only that component, wherein the matching nodes are configured to determine whether different shreds match.

### BACKGROUND OF THE INVENTION

### 1. Field of Invention

The present invention relates to the field of matching data between two or more organizations in a private and secure manner using a distributed data system.

### 2. Description of Related Art

There is a plethora of personal information that is collected online and stored digitally. For one company to share data with another company, they must consider regulatory requirements associated with the sharing of a person's personal details, as well as ethical boundaries. The requirements may vary depending on the field of the industry, for example, banking and medical records would generally have a higher standard than musical or movie tastes, for example. These personal details, often referred to as “Personal Information” (PI), “Sensitive Personal Information” (SPI), or “Personally Identifiable Information” (hereinafter “PII”), are fields or groups of fields found in one or more databases, spreadsheets, cloud providers, and data repositories of an organization, which may identify an individual. In each country, regulations may define those field details that could identify a person in question, and that are therefore subject to control. This PII is sensitive and valued by the individuals that are described by it, and to organizations that collect and store it. Due to increasing awareness of privacy concerns including identify theft, there are increasing regulations worldwide to prevent the communication of PII, yet the data holds a great amount of useful information that may provide useful insights for organizations, were they able to share between them.

In the past, PII and other data has been shared between entities without a respect for the sensitivity of that PII or used only by the entity that collected the data, which presumably already had data security measures in place. However, there is a desire to combine the data from multiple entities to provide further insights to provide customers better products and services; and to share data in a more ethical and private manner.

If data could be combined without contravening the regulations, without directly transmitting PII, the data could be used for other purposes by stripping the data of personally identifiable characteristics, such as name, email, and address.

In an effort to allow data sharing between organizations, tertiary parties to the match process have come into play. These match systems require the organizations to share personal information with the independent party who provides a match table to be used to share data. These independent matching organizations then have access to all of the personal data from many organizations making them “honeypots” for unscrupulous actors.

Based on the foregoing, there is a need in the art for a system to remove the personally-identifiable aspects of data, to permit the data to be shared between entities and across geographies to extrapolate insights from the data. And to decentralize the risk of collecting all PII records into a single organizations control. It would therefore be useful to have a data “shredder” that creates small unidentifiable data portions, of a particular individual on their own, to distribute those “shreds” to multiple parties, and to be able to match the shreds to determine if a person is the same between the original databases.

### SUMMARY OF THE INVENTION

A distributed data system has a network, a first organization connected to the network having a first database having personal identifiable information, the personal identifiable information divisible into a plurality of components, and having a first token associated with the personal identifiable information, and a first personal information gateways in communication with the first database and the network, wherein the personal information gateway is configured to divide the personal identifiable information into a plurality of data shreds, each data shred corresponding to a component, as well as a plurality of matching nodes connected to the network, wherein the nodes are configured to match data, wherein each data shred is configured to be transmitted to a matching node receiving only that component, wherein the matching nodes are configured to determine whether different shreds match.

In one embodiment, there is a second organization having a second database of a second organization having personal identifiable information divisible into a plurality of components and having a second token associated with the personal identifiable information and a second personal information gateway in communication with the second database, wherein the second personal information gateway is configured to shred the personal identifiable information into a plurality of second data shreds, each data shred corresponding to a component, wherein the second data shred is transmitted to the matching node, and wherein the matching node matches a first data token to a second data token if the first and second data shreds match.

In an embodiment, the matching of the first and second tokens permits data that does not contain personal identifiable information to be exchanged between the first and second organization and matched with an individual. The system may also have a policy administration system in communication with the first personal information gateway to provide personal identifiable information rules.

The system may have a data exchange configured to transmit data between the first and second organizations, using the match of the first and second tokens, without transmitting personal identifiable information. In an embodiment, the data shreds are hashed before being transmitted to the matching nodes. The hashed data shreds may be compared by the matching nodes, and the hashed data shreds may be hashed a second time after being matched by the matching node.

In an embodiment, the matching node is configured to provide a matching confidence score based on a number of positive matches. The system may also have more than one matching node, wherein an overall matching confidence score is determined from the matching confidence score of each matching node. The personal information gateways may convert the personal identifiable information of the first organization to binary format. Each of the one or more nodes is configured to store a specific data field.

The distributed data system may have a network, a first organization connected to the network having a first database having personal identifiable information, the personal identifiable information divisible into a plurality of components, and having a first token associated with the personal identifiable information, and a first personal information gateway in communication with the first database and the network, wherein the personal information gateway is configured to divide the personal identifiable information into a plurality of data shreds, each data shred corresponding to a component, a second organization connected to the network, having a second database of a second organization having personal identifiable information divisible into a plurality of components and having a second token associated with the personal identifiable information, a second personal information gateway in communication with the second database, wherein the second personal information gateway is configured to shred the personal identifiable information into a plurality of second data shreds, each data shred corresponding to a component, and a plurality of matching nodes connected to the network, wherein the nodes are configured to match data, wherein each data shred is configured to be transmitted to a matching node receiving only that component, wherein the data shreds are hashed before being transmitted to the matching node, wherein the matching nodes are configured to determine whether different shreds match, and wherein the second data shred is transmitted to the matching node, wherein the matching node matches a first data token to a second data token if the first and second data shreds match, and wherein if the first data token and second data token match, data that is not personal information may be exchanged between the first and second organizations through a data exchange.

A method of transmitting and comparing data is disclosed having the steps of sending data from a first database to a first personal information gateway, the personal information gateway shredding the data according to components, each component corresponding to a matching node, sending data from a second database to a second personal information gateway, the first personal information gateway generating a first token for the data received and sending the unique token back to the database, the second personal information gateway generating a second token for the data received and sending the unique token back to the database, the personal information gateway transmitting the data to one or more matching nodes according to the corresponding component, the first personal information gateway transmitting the matching request to the one or more nodes, each matching node corresponding to a component providing a match confidence score, and the one or more nodes generating a matching table comprising data of matching first and second tokens.

The method may have the additional step of the personal information gateway generating a first token for the data received and sending the unique token back to the database. It may also have the step of removing the data from the database after it has been sent to the personal information gateway. Another optional step is the personal information gateway cleansing and normalizing the data it has received.

In an embodiment, the personal information gateway places a one-way hash on the data it has received such that it does not contain plaintext data. The first and second organizations may exchange data that is not personal information when the first and second tokens are matched, and the first personal information gateway hashes the shredded data.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a visual representation of the distributed data system, according to an embodiment of the present invention.

FIG. 2 is a comparison of tables of the database and the Personal Information Gateway (“PIG”) database and also shows how data moves from its source database and how the unique tokens are appended to the source database, according to an embodiment of the present invention.

FIG. 3 is a comparison of uncleaned and cleaned data fields, according to an embodiment of the present invention.

FIG. 4 is a comparison of data fields before and after hash, according to an embodiment of the present invention.

FIG. 5 is a representation of the division of a hashed field, according to an embodiment of the present invention.

FIG. 5a is a representation of the division of a clear-text field, according to an embodiment of the present invention.

FIG. 6 is a representation of the hashed divided fields being transmitted through the cloud, according to an embodiment of the present invention.

FIG. 6a is a representation of the clear-text divided fields being transmitted through a network or cloud into distributed locations, according to an embodiment of the present invention.

FIG. 7 is a representation of the divided file being subject to a second environment-specific hash, according to an embodiment of the present invention.

FIG. 8 is a representation of the request to match data between accounts, according to an embodiment of the present invention.

FIG. 9 is a table view of double-hashed field matching along with the associated output from an environment's match, according to an embodiment of the present invention.

FIG. 9a is a table view of clear-text field matching along with the associated output from an environment's match, according to an embodiment of the present invention.

FIG. 10 is a table view of the email match results that have been sent to the data exchange from each of the environments which are then filtered (shown in bold) to find a match between two records, according to an embodiment of the present invention.

FIG. 11 is a representation of the use of the matched data record, according to an embodiment of the present invention.

FIG. 12 is a flowchart showing the steps of the distributed data system, according to an embodiment of the present invention.

### DETAILED DESCRIPTION OF PREFERRED EMBODIMENTS

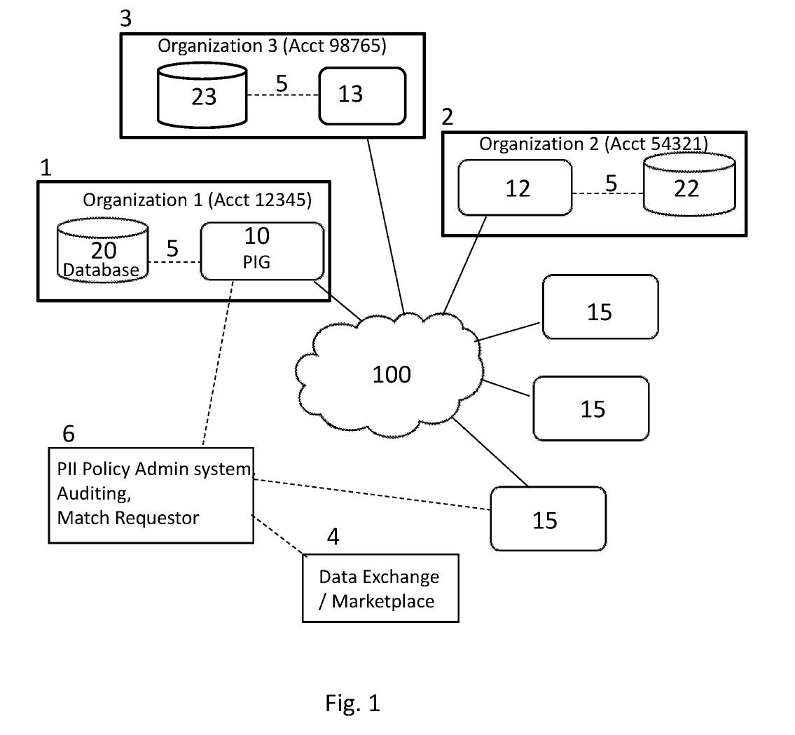

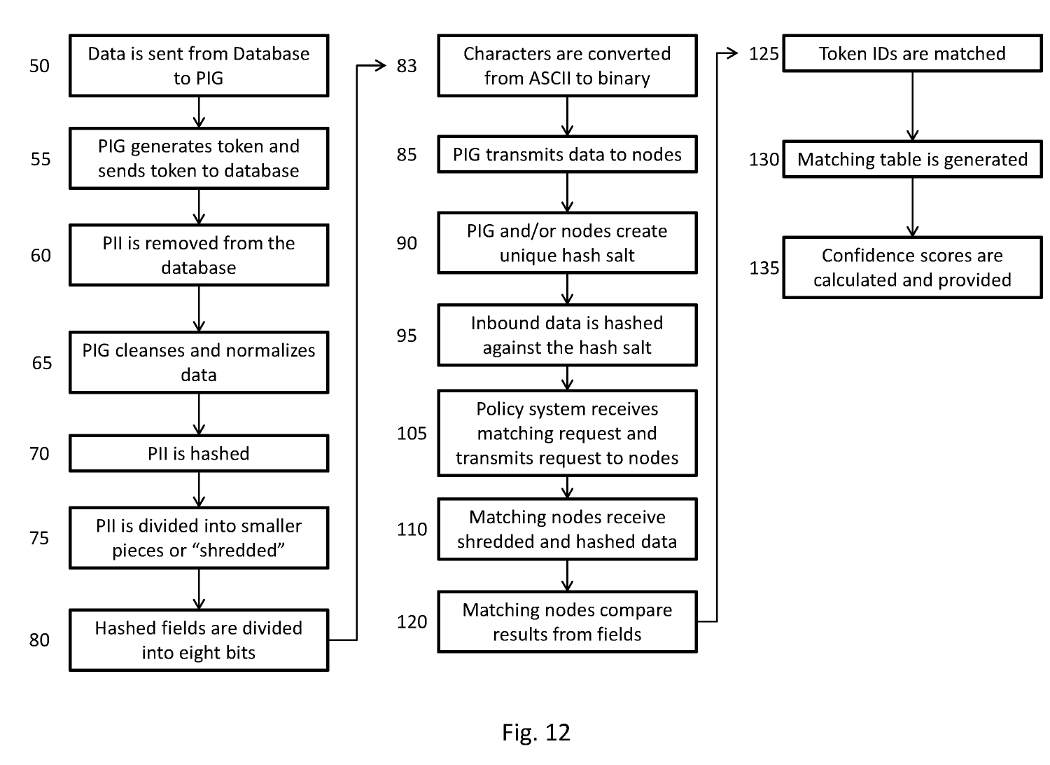

Preferred embodiments of the present invention and their advantages may be understood by referring to FIGS. 1-12, wherein like reference numerals refer to like elements.

In reference to FIG. 1, an embodiment of the present invention is shown, wherein represents a database 20 of a first organization 1 containing data on customer transactions or other business data, along with data attributes therefor. The data attributes include unregulated data fields as well as regulated fields commonly referred to as Personally Identifiable Information (“PII”) which have been gathered by the organization. PII within the database 20 may include information such as name, email, address, telephone numbers, birthdate, and/or digital fingerprints and biometrics information, in an embodiment. The PII usually contains this data in individual fields, and fields are connected together to identify an individual across the tables of the database through at least one unique token. The database is connected to a Personal Information Gateway (hereinafter “PIG”) 10 that processes data before it is sent outside of the organization 1, and the PIG 10 is connected to, and in communication with, the cloud 100 and other nodes 15 and other organizations 2, 3 through the cloud 100, as well as a policy administration system 6. The PIG stands between the database 5 and the cloud 100. There may be a firewall and other network components (not shown) between the PIG 10 and the cloud 100.

In the preferred embodiment, when the first organization 1 wishes to send data from the database 20 to a second organization 2, to be combined with the data of the second organization, the data to be transmitted is split into PII records and non-PII records. The PII records are passed from the database 20 to the PIG 10 within the first organization 1. The PIG consists of a system which processes or “shreds” the PII into granular data elements (data shreds), typically individual fields of the PII. The granularity may be smaller, in the form of parts of fields (individual or small groups of characters) or parts of the ASCII characters forming the data. Each information field is broken into smaller portions by the PIG 10 as it is prepared for transmission, and is attributed a token ID that is unique to the complete PII record. The Token ID provides the PIG 10 with a way to link granular parts of PII together to determine the identity of the record. The information is transformed or shredded by the PIG 10 into portions small enough to strip the information down to data that cannot be considered PII. The data is transmitted to nodes 15 for further processing. Those transmissions may be secured within virtual private networks, secured by a secured socket layer (SSL) or equivalent technology and may only accept transmissions within a whitelist of subscribers.

The PIG may process the information to reduce identifiability in other ways than shredding, such as combining multiple fields, or maintenance of pseudo-records and/or aliases to match field values, albeit with a lowered match confidence or probability.

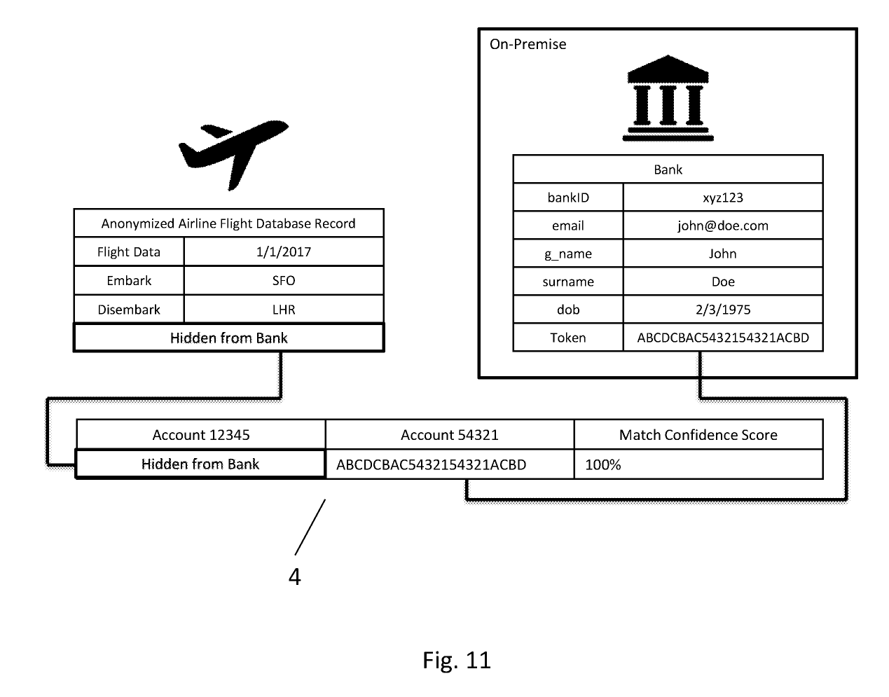

The organization 1 is connected to other organizations 2, 3 through the cloud 100, wherein each organization has a gateway for the data of a PIG 22, 23. Each organization 1, 2, 3 is connected to the policy administration system 6. The Policy Administration system 6 contains data policy information as to what is considered PII, which policies may be provided by regulatory or government bodies, both domestic and international, and determines what may be transmitted between which type of organizations, defining what is an acceptable or allowable match. The Policy Administration system 6 is connected to a data exchange 4. The data exchange 4 facilitates anonymized data transfer using tokens, and uses a record, or match list, of corresponding tokens between different organizations 1, 2, 3. The data exchange 4 may send non-PII attributes appended to tokens, as described in further detail in FIG. 11. The policy administration system 6 may be programmed for policy rules in advance, or may be in communication with a regulatory body such that policy rules may be updated by the regulatory body. The policy administration system may be a distributed system managed by more than one regulatory party.

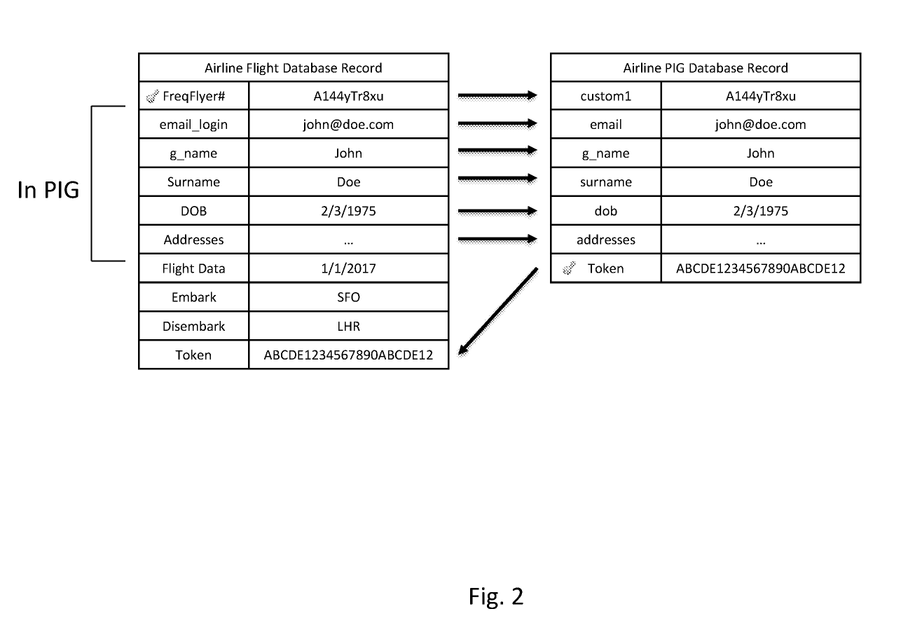

With reference to FIG. 2, an airline flight database record is shown, having the fields (example database field name is in parentheses) of frequent flyer (FreqFlyer), email login (email_login), given name (g_name), surname, date of birth (DOB), addresses, as well as flight data for the particular flight that this customer has booked, such as Flight Date (flight_date), embarking airport (embark), disembarking destination (disembark). This record is representative of a particular flight for an individual. In this example, email_login, g_name, surname, DOB and addresses are considered PII, for which transmission is therefore restricted. In step 50 these fields are therefore passed to the PIG 10 from the database 20 in the form of the Airline PIG Database Record. The PIG, having received the PII from the database 20, in step 55 passes a PIG-generated token back to the database 20 to be used later when transmitting or receiving non-PII attributes from partner organizations through the data exchange 4. Optionally, in step 60 the PII information that has been transferred to the PIG 10 can be removed from the database 20, thus anonymizing the data and reducing the risk of hacking of the database 20.

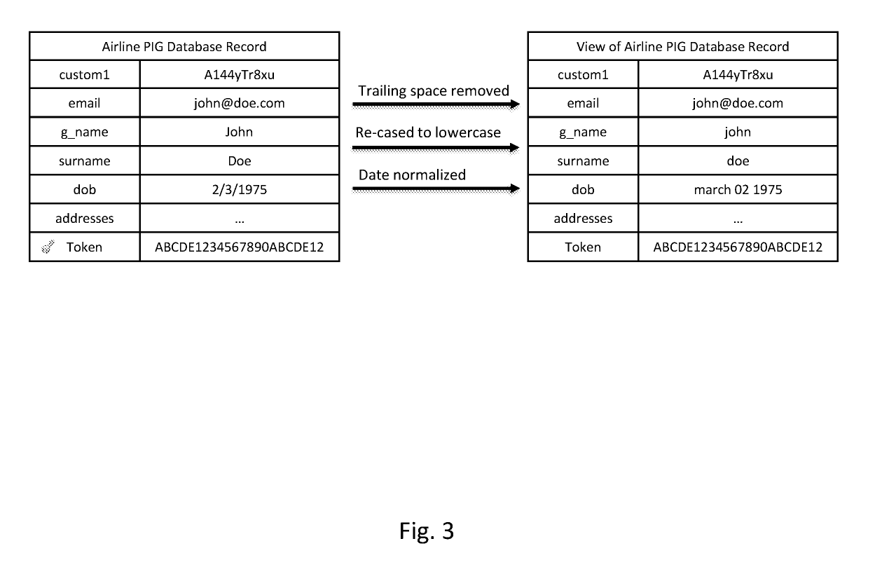

With reference to FIG. 3, once the data is within the PIG 10, in step 65 the PIG 10 optionally cleanses and normalizes the data. For example, leading and trailing spaces are removed, text may be reduced to lower case, dates, dollar amounts and addresses are converted to a standard format, and zip codes may be verified against cities and states.

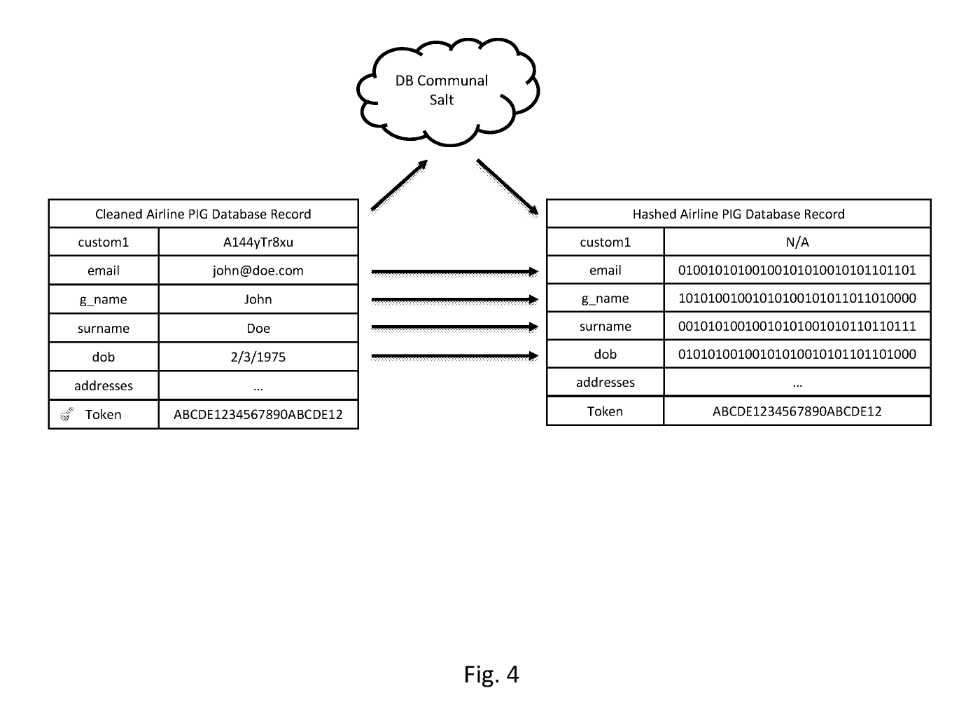

With reference to FIG. 4, once the data is cleansed within the PIG 10, in step 70 optionally the record is hashed to obfuscate the shredded elements further. In the preferred embodiment, the hash is a one-way function for obfuscating the PII while still enabling it to be compared with the matching shred of another organization, and therefore allows for later use without keeping and risking the plaintext data shred. An organization can request data on the other party's token once the match is made and the match recorded in a match correspondence table. The hash may use a communal salt (random data used as addition input) or other agreed-upon salt to transform the data.

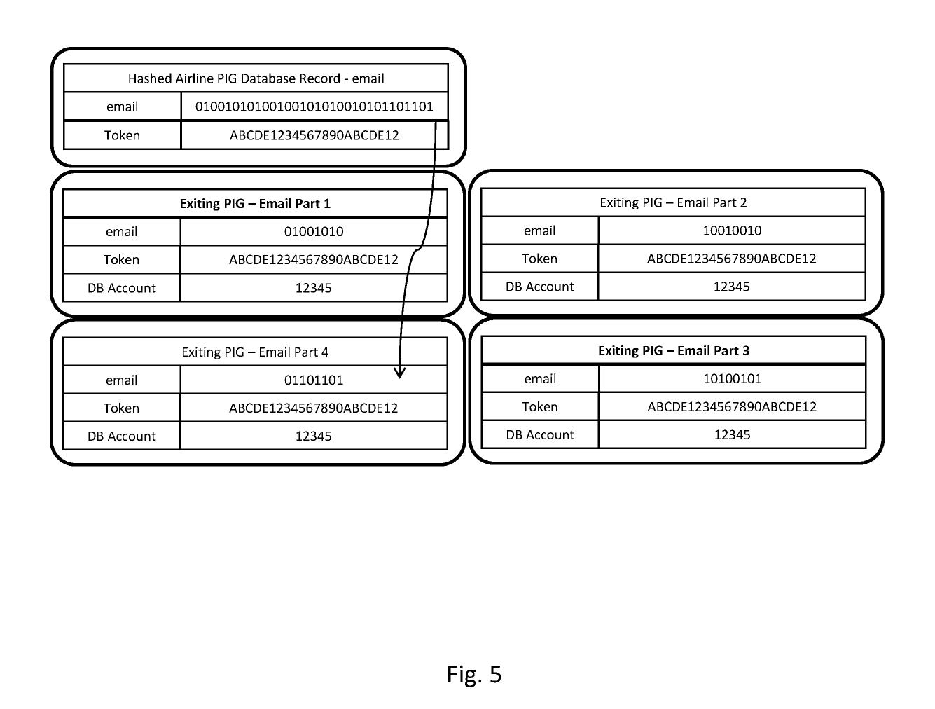

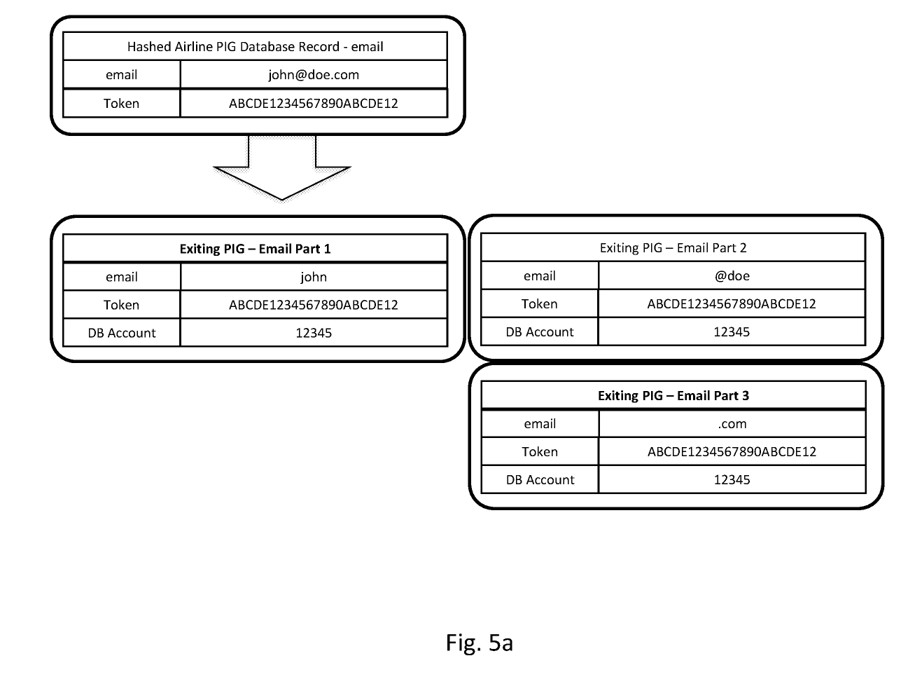

With reference to FIG. 5, the cleansed and hashed data is “shredded” or divided into smaller pieces by the PIG at step 75. For example, a full name may be broken into two parts, a given name (g_name) and surname (s_name), and given a given name of John, the g_name may be divided into as many letters as the name has, namely “J”, “O”, “H”, and “N”. Since each of the fields is hashed into a standard length, in step 80 the fields may be divided into eight bits each, each also having the same token associated therewith to identify to the PIG 10 or database 20 the identity of the record. In FIG. 5a, a plaintext example is shown, wherein the email (without hashing) is shredded into three fields, a first part “john”, a second part “@doe”, and a third part “.com”, representing the form that data exits the PIG.

In an embodiment of the data shredding by the PIG 10, wherein the data is not hashed, in step 83 the alphanumeric characters of data entries are converted from ASCII to binary, wherein the binary coding may be further broken up to better anonymize data before being transmitted, and to make any reconstruction meaningless and difficult. For example, an 8-bit binary ASCII character may be broken into two 4-bit nibbles. Future iterations could break that down further into 2-3 bit portions. Further, a secure tunnel (VPN) is generated between the PIG 10 and the nodes 15, to prevent interception of information sent through the tunnel.

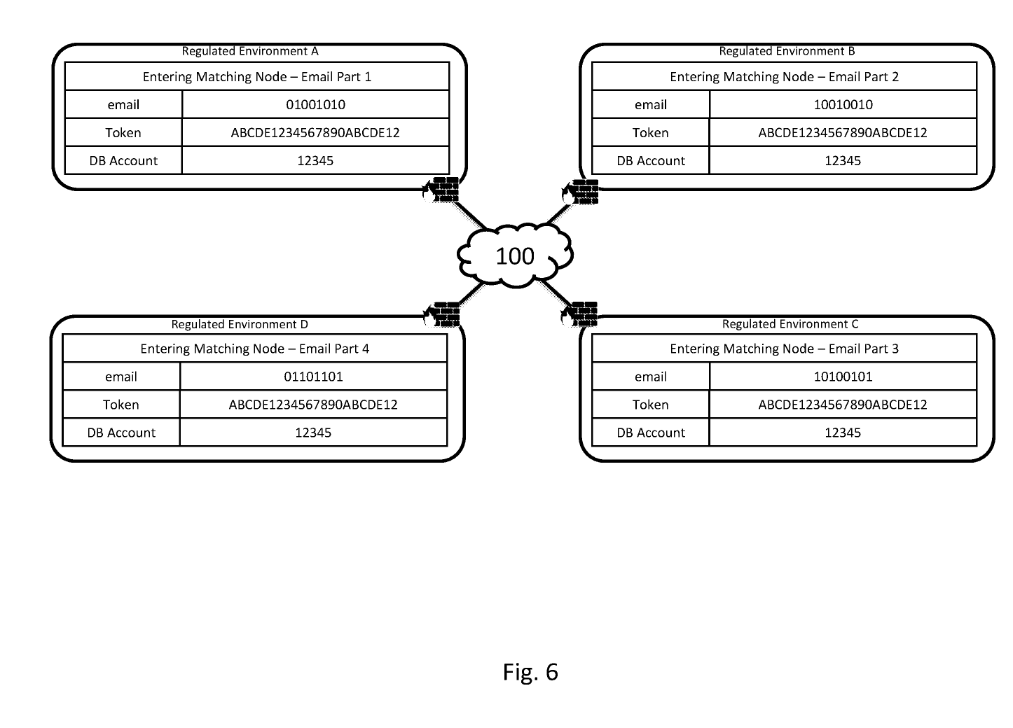

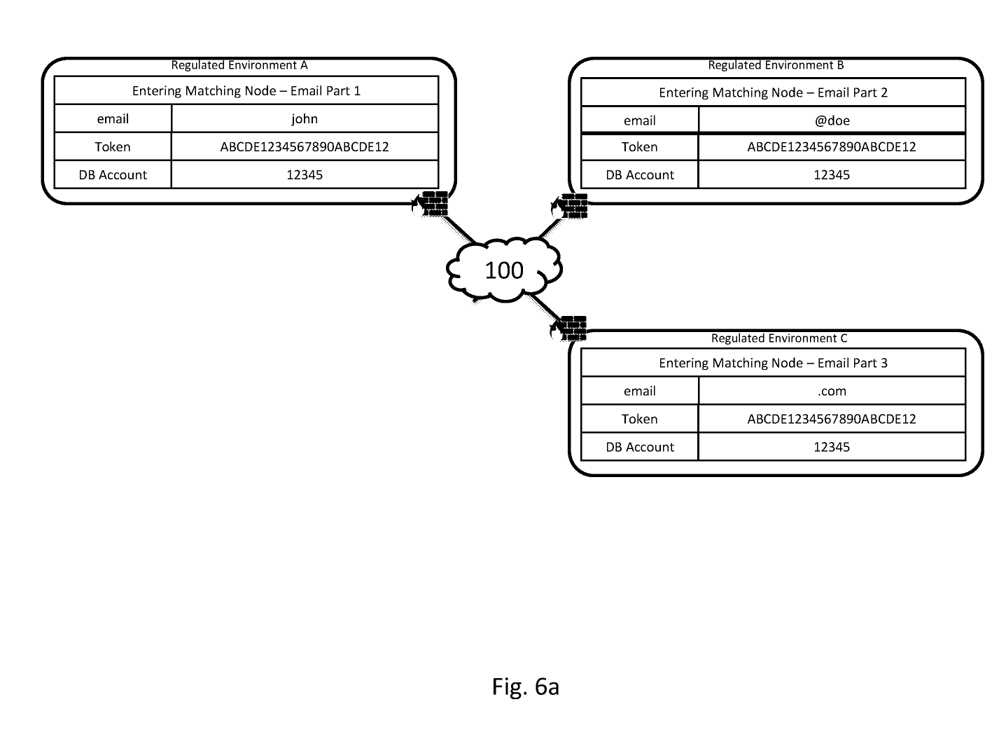

With reference to FIG. 6 and in step 85 the PIG 10 will then transmit the data into one or more nodes 15 through the cloud. The transmission of data is accomplished through a secured network or cloud 100 to other nodes 15 or organizations 1, 2, 3. Replicas or parity copies of these PII fields can be stored in multiple nodes 15. Nodes may be matching nodes that compare PI shreds from 2 or more organizations 1, 2, 3, or contribution nodes that manage and submit data to the network of “matching” nodes 15, or both matching and contribution nodes. In an embodiment, the PIG 10 is the contribution node 15. The PIG 10 controls which matching nodes the organizations 1, 2, 3 want their data stored in. With reference to FIG. 6a, the plaintext email is divided into three components or parts, part 1 being the name “john”, part 2 being the domain “@doe”, and part 3 being the TLD “.com”. Each of these is transmitted through the cloud to a “matching” node that corresponds to the type of data, that is, part 1 of the email address is transmitted to a node containing only part is of email, in an embodiment, and part 2 is transmitted to a node that contains only part 2s of email, and so on. That way, when the data is matched between organizations, it is known what kind of data the field contains, so matches of field parts can be accurately made and an accurate token match list can be output.

In one embodiment, each node carries a particular portion of the information, for example, if an email address is divided into 3 parts by the data shredding, Node A always receives the first part, Node Y always receives the second part, and Node Z always received the third part of the email address. Due to the shredding and distribution of the data, no one node 15 contains enough information to re-identify a person or be considered PII. In this way, personal information may stored on a torrent style network where all nodes 15 contribute to the distribution of the shreds of the original PII data.

The nodes 15 are connected to the cloud in a torrent-style network. The data may be received non-sequentially, maximizing the efficiently of different network connection between the nodes and the organizations. Data is received by organizations from many small data requests over different IP connections to different nodes, and reassembled from the small data requests on-site, as is common in torrent-style system.

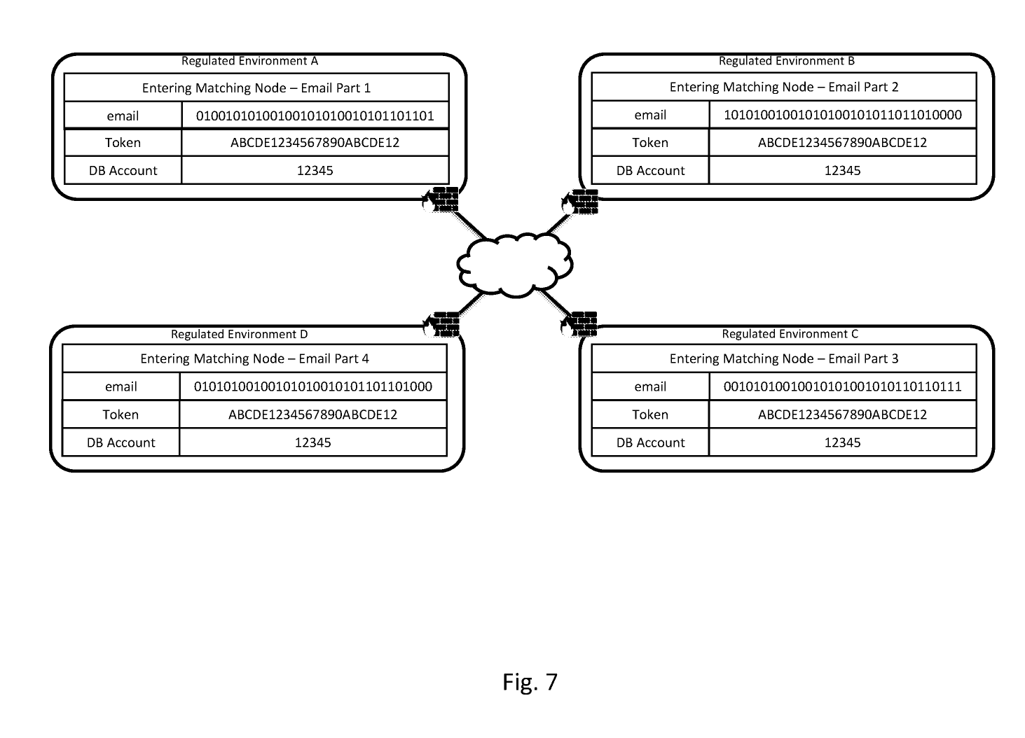

With reference to FIG. 7, in step 90 each PIG 10, 12, 13 or node 15 that receives data creates a unique hash salt that each inbound record is hashed against in step 95. Therefore, the previously shredded and communal hashed data is optionally hashed again to create a double hash. The data is hashed two times—the first as the data leaves the PIG 10, 12, 13, and the second time as the data is received by a node 15 or a PIG 10. In a further embodiment, the first hash is not a communal hash, rather it is chosen by the contributing organization before the data exits the PIG 10 and the hash key is sent through the policy administration system 6 to the match nodes 15 before the match is initiated.

In an embodiment, the contributing party will encrypt or hash their data using a key or salt known only to them. The key or salt would be submitted through the management system into the matching nodes during the matching phase to unlock the used of their shred(s). This process can be likened to the two-key systems used in safe deposit boxes.

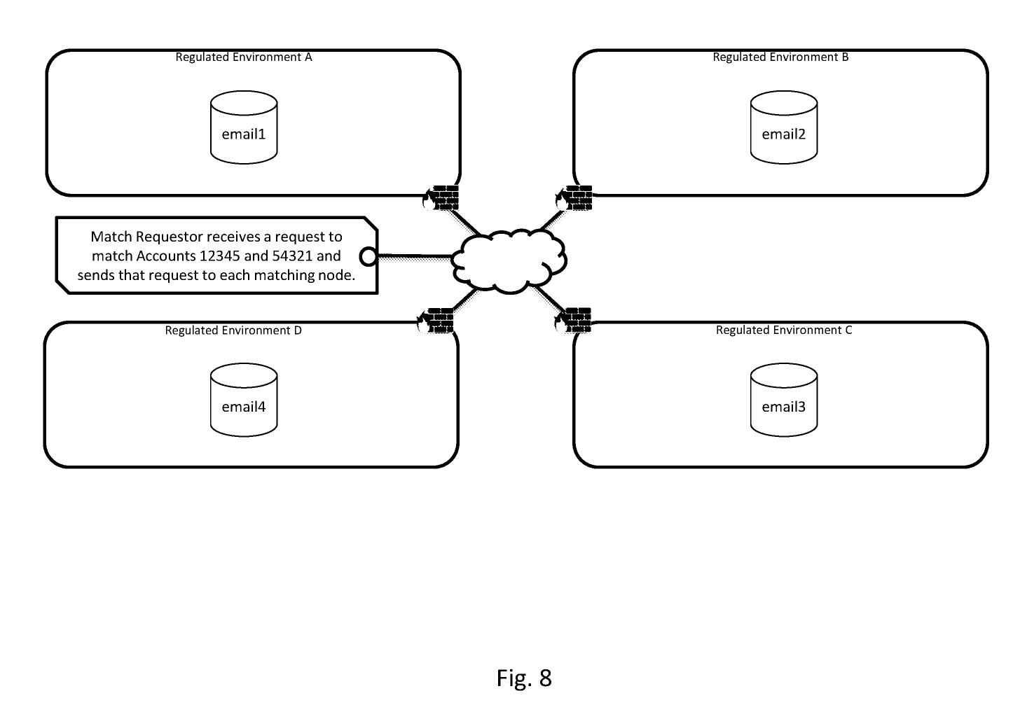

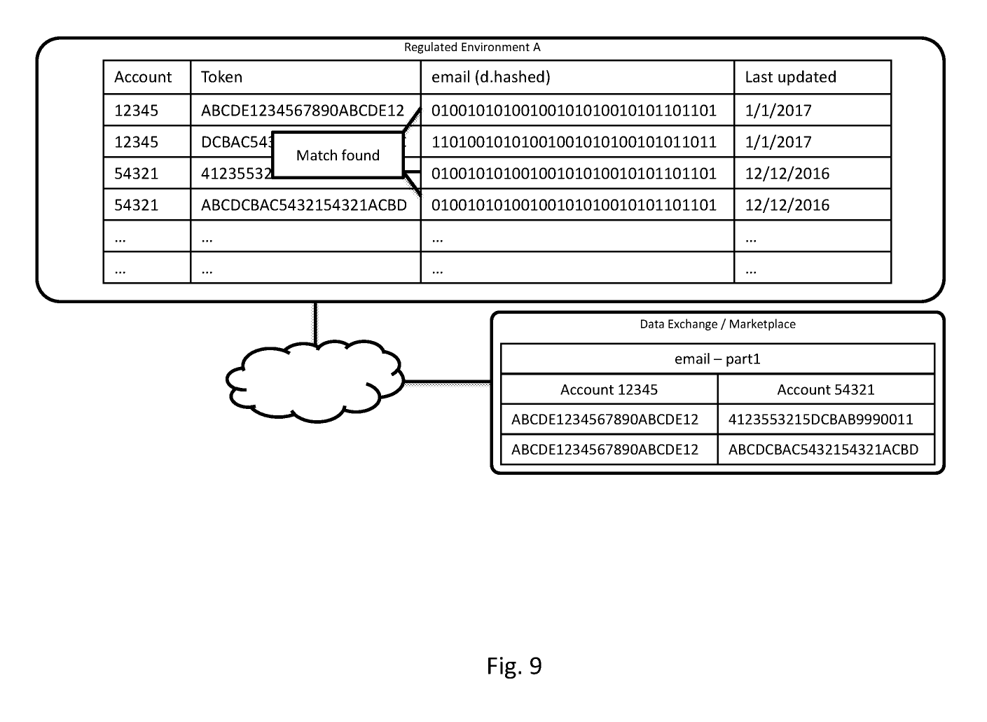

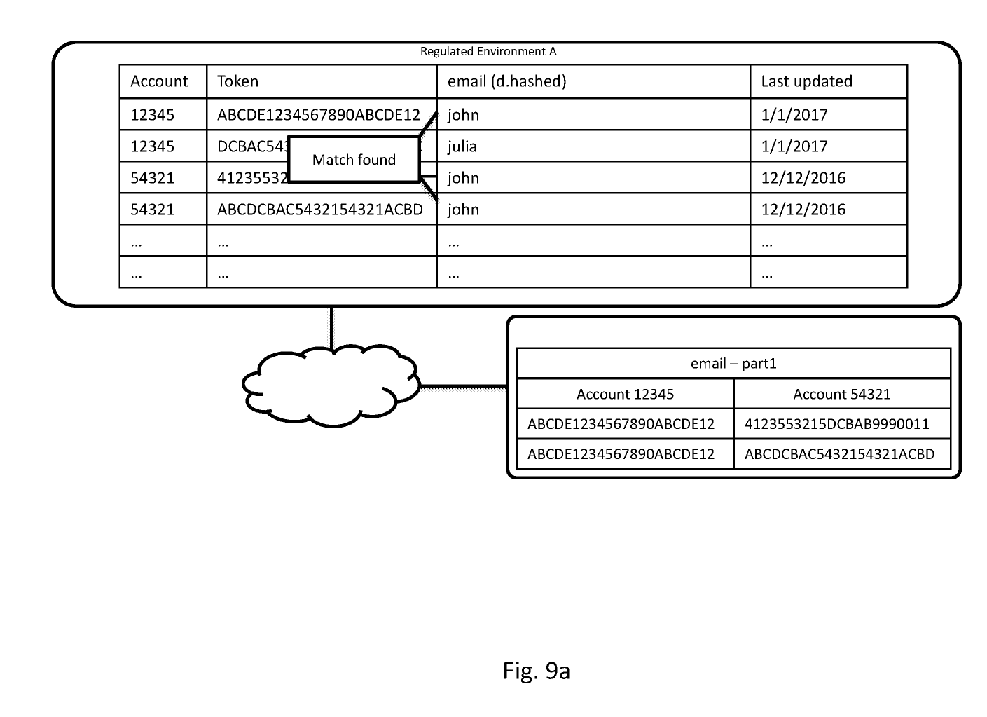

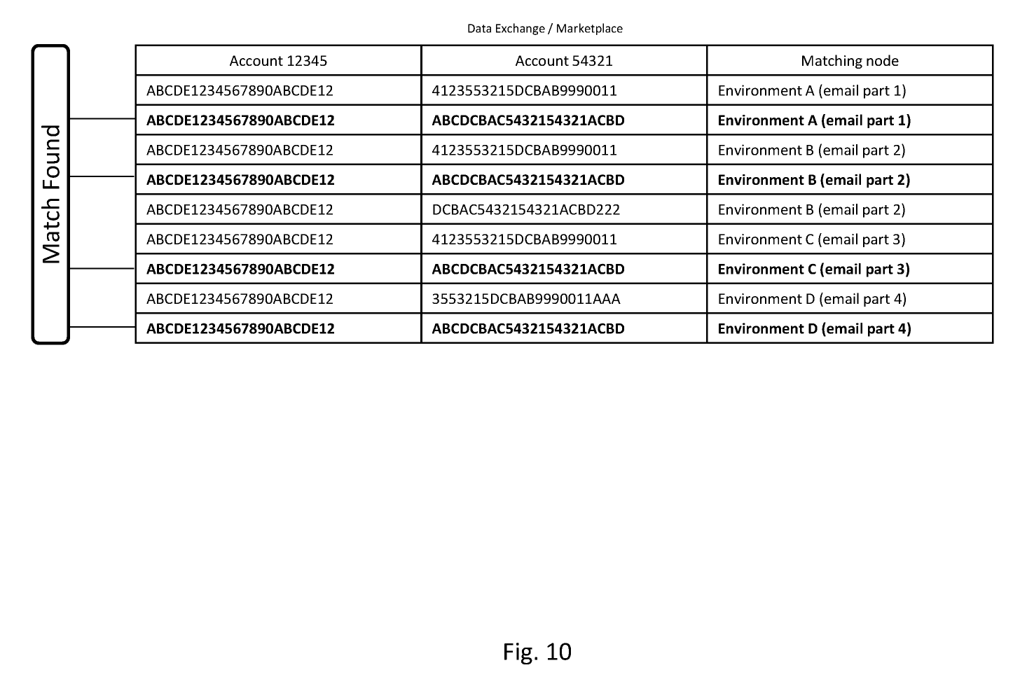

With reference to FIG. 8, in step 105 the policy system 6 receives a request from an organization 2 to match two organization's PII records that may have originated from databases 22, 20, and it sends that request to each matching node 15. In an embodiment, the PIG 10, 12 does not receive an external request except that of the policy system 6, which regulates whether a match is permitted to occur. With reference to FIG. 7, in step 110 the matching nodes 15 receive the shredded and hashed data from the PIG 12 and 10. In step 120, as shown in FIGS. 9 and 10, the matching nodes compare the results field by field to determine whether a match exists and in some embodiments what the probability of the match is. Where the hash results match, the underlying PII element data will also match, and the node 15 creates a match table entry for the token ID of organizations 1, 2. In FIG. 9a, two plain text matches are shown between the organizations 1, 2 on the first part of the email field, wherein one organization 1 account token has the name “john” and wherein two organization 2 account tokens have the name “john”. The corresponding token ID matches are placed into a table and transmitted to the data exchange or policy administration system. In FIG. 10, the token IDs of example accounts 12345 and 54321 are matched in step 125, therefore the matching nodes know which data from the first database 22 match with which data from the second database 20.

With reference to FIG. 10, data aggregation filtering “voting” is shown, wherein the match results from each environment associated with the email field are received and compared and subsequently filtered. As can be seen in FIG. 10, for the given Token ID of organization 1 (Account 12345), namely ABCDE1234567890ABCDE12, there are two matches for matching the hashed part 1 of the email, three matches for part 2 of the hashed email, and two matches for each of parts three and four of the hashed email. However, of these matches, there is only one 54321 account, namely ABCDCBAC5432154321ACBD, that matches with all four parts of the email. Therefore, the tokens may be matched with 100% confidence. Depending on the number of matches, a probability rating for a successful match, and matches with less than 100% confidence may still be used.

With reference to FIG. 11, the matched tokens for the two organizations 1, 2 are communicated to the data exchange 4 along with the confidence score, and anonymized air flight data can now be transmitted through the data exchange and used by the bank by the Token matching of step 125. The bank has PII in the form of email, given and surnames, and DOB, along with a key. The anonymized flight database record has flight information, along with a Token. The account number for the flight database is obfuscated from the bank, but the flight data may be confidently matched to the PII of the bank's individual record, without the PII data being transmitted through the cloud. A matching table is derived in step 130 from the aggregation filter (“voting”) step 125 and is used to create a view for the bank so the bank may determine who is flying when, to inform fraud handling and prevent a fraud alert from an overseas purchase. The token for the airlines is hidden from view but the token from the bank is visible to the bank. Optionally, in step 135 a match confidence score is calculated and provided.

In the preferred embodiment, the PIG 10 will be in communication with a policy administration system 6 to ensure proper regulation of data being transmitted. The policy administration system 6 describes whether a match is permitted ethically or legally, after applying rules regarding the type of information, its final destination (national or international, taking into account jurisdictional peculiarities, and optionally what other information is being transmitted alongside the information. Additionally, blacklists could be implemented via the PII policy administration system 6, to keep data or metadata from being obtained by a competitor's organization. Examples may include a blacklist for banks transmitting to another financial institution. In one embodiment, a permitted use governance system may be used to manage the white and black lists by the organizations themselves.

Each of the nodes 15 and organizations 1, 2, 3 are connected to a network, preferably the Internet to pass through a cloud. Due to the risk of interception of traffic that passes through publicly available networks, the data intended for communication is hashed before transmission, wherein the data hashes to a unique hash value, and wherein the data cannot be un-hashed to reveal the original data. There are a number of hash functions known in the art that could be used, for which a non-limiting example might be SHA or its variants. Preferred hash functions always produce the same output for a given input, and map the inputs as evenly as possible over the output range, and good hash functions also have a circumscribed output range. Ideally, to reduce ambiguity, the hashes are unique and for a given value only a single hash output is the result.

Each of the matching nodes 15 has a matching engine built in. In one embodiment, the contributor nodes also match and have a matching engine built in. The matching node 15 receives data from multiple organizations 1, 2, 3. If a particular data entry exists in multiple organizations 1, 2, 3, a simple grouping of those data entries is created within the node 15. In an embodiment, the nodes 15 are independent of the organizations 1, 2, 3. They are connected to the network 100, and are distributed similar to a torrent in one embodiment. In an embodiment, each node maintains a particular piece of the shredded data for multiple data records, so in an example a particular node may contain thousands of second triplets of users' telephone numbers, while another node may contain only the first triplet of users' telephone numbers. If an event arises wherein the originating organization 1 would like to utilize attributes of receiving organization 2, identity-matching needs to occur to ensure that the individual is the same person. The Policy Management System 6 receives a request for a match between two individuals' PII data in order to facilitate an exchange of attributes for an existing customer. Once the policy engine has approved the request, a match request will be sent out to each node requesting the two Tokens of any “MATCHED” requests for those accounts. Each node would independently respond with a table containing tokens that match the request

Optionally, during a match request, a map will be created to confirm all bits are available between parties and report missing components if required. This will allow the PIG admin to add additional nodes to increase the quality of the matching map. Even though this is permitted by the technology, it may be restricted from a regulatory point of view.

The organizations 1, 2, 3 are connected to the cloud 100 (generally a server network) through their PIGs 10. A number of nodes 15 are also connected to the cloud and may communicate with the organizations 1, 2, 3 through their PIGs 10, and may also communicate directly with other nodes 15. In an embodiment, the data will be further encrypted using a one-way hash using any one of a number of hash functions known in the art. In an embodiment, the hash is used when the data first exits the organization 1, 2, 3 by the PIG 10. This ensures that during its transmission to the storage node(s), it cannot be seen in clear text to maintain data privacy. Optionally, a second one-way hash is applied by the receiving node 15 when the data is received, and the data is stored in a double-hashed format, which further obfuscates the data and makes it impervious to any other site attempting to hack that location from the cloud. This also adds to layers of protection that make it so the PI bank management organization will not be allowed to get into someone's actual data.

In an embodiment, for each action on any given node, a transaction is recorded against a common ledger so that an immutable record exists on each match ever requested. In one embodiment, the ledger is recorded as a blockchain, such that prior records cannot be altered, and an audit path is always maintained. In an embodiment, a multi-tiered encryption model is used in which a transaction data block of the actor is individually encrypted, a transaction data block of each transaction is individually encrypted, and a chain of data blocks is encrypted. Before decrypting the data pertaining to a party of a transaction, the chain of data blocks must be decrypted, followed by a decryption of the transaction's transaction data block, followed by a decryption of the party's transaction data block. In this way the placement and use of all PII by any employee of an organization is now fully captured in an independent, immutable, and distributed way.

In an embodiment, each Company Database can replace their PII with tokens. Any person or application requiring the use of PII would use a governance engine that supports permitted use of that data. In this way, the PIG 10 becomes the single source of all PII data within an organization as well as the single place requiring protection and management. This improves and standardizes records management and data cleansing while maintaining internal data security measures. In another embodiment, the PIG 10 may actually be formed of two components, a first that holds the master records (on a secluded network) and a second that stores the hashed shredded records and can communicate directly with the Internet.

In an embodiment, the initial architecture of the system will require there to be enough nodes to ensure no single node can re-identify a person. For example, if Node 1 held a given name and surname, or a surname and phone number, that could be enough to re-identify. Even though all chunks are stored in an encrypted way, this will ensure that the data stays de-identified. Some other PI chunks could be placed together with less risk such as birth month and city. In the embodiment, the data schema is laid out in such a way as to ensure no single point of failure could cause an outage in the use of data. Whether through redundant copies or multiple parity chunks such as what is employed with object storage or other scale-out storage solutions can be used.

In an embodiment, due to the distributed nature of the deployment, each organization will have used varying levels of security. A hacker would be required to hack multiple environments simultaneously to retrieve useful data. Even then, it may be similar to retrieving a large phone book with an arbitrary account number as the single identifier of the provider organization.

In an embodiment, a binary conversion may be utilized to convert alphanumeric characters to binary to increase the granularity of the distribution of characters. As more complex characters are intended for use, the coding should not be limited to UTF-8. Because of distributing the binary elements, even letters of a name are unintelligible to the PIG storing the data and the matching process between organizations will take little processing to accomplish.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A distributed data system having:
a. a network;
b. a first organization connected to the network comprising:
i. a first database having personal identifiable information, the personal identifiable information divisible into a plurality of components, and having a first token associated with the personal identifiable information; and
ii. a first personal information gateways in communication with the first database and the network, wherein the personal information gateway is configured to divide the personal identifiable information into a plurality of data shreds, each data shred corresponding to a component;
c. a plurality of matching nodes connected to the network, wherein the nodes are configured to match data,
wherein each data shred is configured to be transmitted to a matching node receiving only that component, wherein the matching nodes are configured to determine whether different shreds match.

2. The distributed data system of claim 1, further comprising a second organization comprising:
a. a second database of a second organization having personal identifiable information divisible into a plurality of components and having a second token associated with the personal identifiable information; and
b. a second personal information gateway in communication with the second database, wherein the second personal information gateway is configured to shred the personal identifiable information into a plurality of second data shreds, each data shred corresponding to a component,
wherein the second data shred is transmitted to the matching node, and wherein the matching node matches a first data token to a second data token if the first and second data shreds match.

3. The distributed data system of claim 1, wherein the matching of the first and second tokens permits data that does not contain personal identifiable information to be exchanged between the first and second organization and matched with an individual.

4. The distributed data system of claim 1, further comprising a policy administration system in communication with the first personal information gateway to provide personal identifiable information rules.

5. The distributed data system of claim 1, further comprising a data exchange configured to transmit data between the first and second organizations, using the match of the first and second tokens, without transmitting personal identifiable information.

6. The distributed data system of claim 1, wherein the data shreds are hashed before being transmitted to the matching nodes.

7. The distributed data system of claim 2, wherein the hashed data shreds are compared by the matching nodes.

8. The distributed data system of claim 6, wherein the hashed data shreds are hashed a second time after being matched by the matching node.

9. The distributed data system of claim 2, wherein the matching node is configured to provide a matching confidence score based on a number of positive matches.

10. The distributed data system of claim 1, comprising a plurality of matching nodes, wherein an overall matching confidence score is determined from the matching confidence score of each matching node.

11. The distributed data system of claim 1, wherein the personal information gateways convert the personal identifiable information of the first organization to binary format.

12. The distributed data system of claim 1, wherein each of the one or more nodes is configured to store a specific data field.

13. A distributed data system having:
1) a network;
2) a first organization connected to the network comprising:
i) a first database having personal identifiable information, the personal identifiable information divisible into a plurality of components, and having a first token associated with the personal identifiable information; and
ii) a first personal information gateway in communication with the first database and the network, wherein the personal information gateway is configured to divide the personal identifiable information into a plurality of data shreds, each data shred corresponding to a component;
3) a second organization connected to the network, comprising:
i) a second database of a second organization having personal identifiable information divisible into a plurality of components and having a second token associated with the personal identifiable information; and
ii) a second personal information gateway in communication with the second database, wherein the second personal information gateway is configured to shred the personal identifiable information into a plurality of second data shreds, each data shred corresponding to a component; and
4) a plurality of matching nodes connected to the network, wherein the nodes are configured to match data,
wherein each data shred is configured to be transmitted to a matching node receiving only that component, wherein the data shreds are hashed before being transmitted to the matching node, wherein the matching nodes are configured to determine whether different shreds match, and wherein the second data shred is transmitted to the matching node, wherein the matching node matches a first data token to a second data token if the first and second data shreds match, and wherein if the first data token and second data token match, data that is not personal information may be exchanged between the first and second organizations through a data exchange.

14. A method of transmitting data comprising of:
a. sending data from a first database to a first personal information gateway;
b. the personal information gateway shredding the data according to components, each component corresponding to a matching node;
c. sending data from a second database to a second personal information gateway;
d. the first personal information gateway generating a first token for the data received and sending the unique token back to the database;
e. the second personal information gateway generating a second token for the data received and sending the unique token back to the database;
f. the personal information gateway transmitting the data to one or more matching nodes according to the corresponding component;
g. the first personal information gateway transmitting the matching request to the one or more nodes;
h. each matching node corresponding to a component providing a match confidence score; and
i. the one or more nodes generating a matching table comprising data of matching first and second tokens.

15. The method of transmitting data of claim 14, further comprising the step of the personal information gateway generating a first token for the data received and sending the unique token back to the database.

16. The method of transmitting data of claim 14, further comprising of removing the data from the database after it has been sent to the personal information gateway.

17. The method of transmitting data of claim 14, further comprising of the personal information gateway cleansing and normalizing the data it has received.

18. The method of transmitting data of claim 14, further comprising of the personal information gateway placing a one-way hash on the data it has received such that it does not contain plaintext data.

19. The method of transmitting data of claim 14, wherein the first and second organization may exchange data that is not personal information when the first and second tokens are matched.

20. The method of transmitting data of claim 14, wherein the first personal information gateway hashes the shredded data.
